(19) United States
(12) Patent Application Publication
(10) Pub. No.: US 2011/0211050 A1
(43) Pub. Date: Sep. 1, 2011

(54) AUTOSTEREOSCOPIC DISPLAY OF AN IMAGE

(76) Inventor: Amir Said, Palo Alto, CA (US)

(21) Appl. No.: 13/127,015

(22) PCT Filed: Oct. 31, 2008
(86) PCT No.: PCT/US2008/082132

§ 371 Date: Apr. 29, 2011

(51) Int. Cl. H04N 13/04

(52) U.S. Cl. 348/51; 348/E13.075

(57) ABSTRACT

In a method of creating an autostereoscopic display of an image, a plurality of images are received at a spatial-resolution-to-angular-resolution-converter. The plurality of images each have differing incident angles with respect to the spatial-resolution-to-angular-resolution-converter. An autostereoscopically displayed image is created from the plurality of images using the spatial-resolution-to-angular-resolution-converter.

### BACKGROUND

Autostereoscopic displays of images provide a viewer with three-dimensional depth perception relative to a viewed displayed image, without requiring the use of special apparatus such as glasses with differently colored (e.g. red and green) lenses or polarizing filters. Instead, the stereo qualities are integral to the autostereoscopic display of an image and can thus be seen by human eyes without the use of a special viewing apparatus.

Many mechanisms are known for producing autostereoscopically displayed images and include mechanisms such as flat panel displays and projection screens. Even though mechanisms such as a flat panel display and a projection screen are essentially flat, the produced autostereoscopically displayed image provides a display of an image which affords depth perception to one or more viewers and from multiple viewing angles/locations.

### BRIEF DESCRIPTION OF THE DRAWINGS

The accompanying drawings, which are incorporated in and form a part of the Description of Embodiments, illustrate various embodiments of the present invention and, together with the description, serve to explain principles discussed below:

FIG. 1 is an autostereoscopic display creation system, according to an embodiment.

FIG. 2 shows enlarged detailed views of a portion of an autostereoscopically displayed image, according to various embodiments.

FIG. 3 is a flow diagram of a method of creating an autostereoscopically displayed image end calibrating an autostereoscopically displayed image, according to various embodiments.

FIG. 4 is a diagram of an example computer system used in accordance with various embodiments.

The drawings referred to in this Brief Description should not be understood as being drawn to scale unless specifically noted.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments of the subject matter as defined by the appended claims. Furthermore, in the following Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

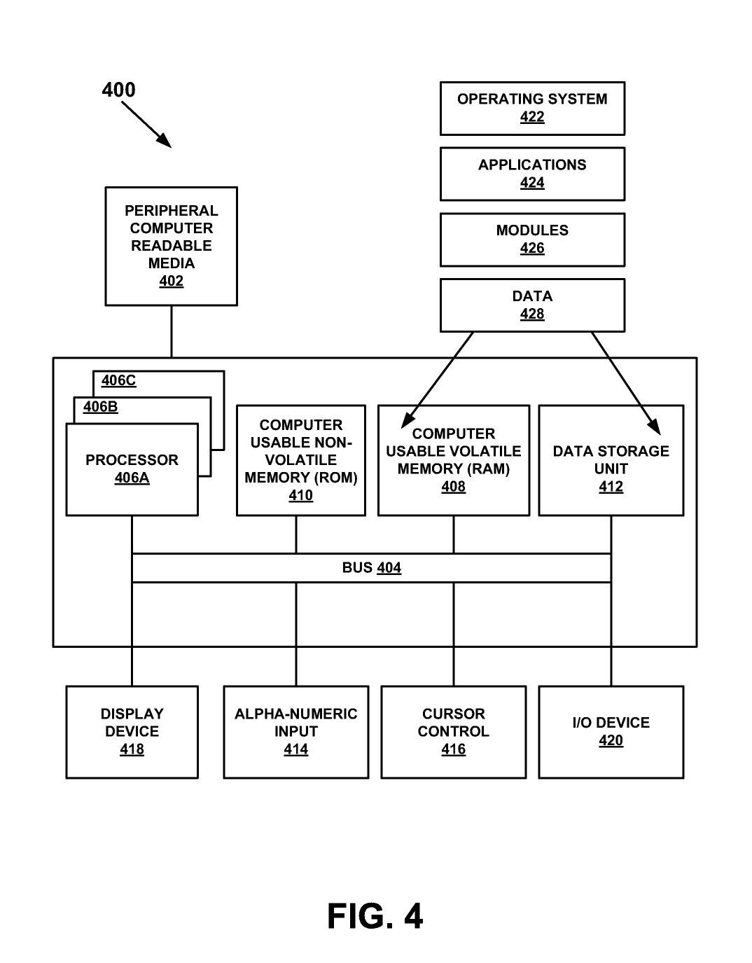

Unless specifically stated otherwise as apparent from the following discussions, it is appreciated that throughout the present Description of Embodiments, discussions utilizing terms such as “calibrating,” “evaluating,” “generating,” “selecting,” or the like, refer to the actions and processes of a computer system (such as computer 400 of FIG. 4), or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Some embodiments of the subject matter are also well suited to the use of other computer systems such as, for example, optical and virtual computers.

### Overview of Discussion

Embodiments described herein provide methods and systems for improving the visual quality of integral imaging autostereoscopic three-dimensional (3-D) displays created via digital projector(s) and a lens array. Due to limited projector resolution, current methods of creating autostereoscopically displayed images produce severe blurring and spatial aliasing, rendering 3-D views of very poor quality. Techniques described herein achieve more accurate focusing by changing the optical arrangement of the combination of projector and lenses and by controlling an amount of light diffusion in the lens back, and by utilizing an array of projected images in the creation of an autostereoscopic image.

Discussion will begin with a description of an example autostereoscopic display creation system, which operates to create, display, and in some embodiments calibrate a created autostereoscopically displayed image and/or the system used to create the image. Components of the autostereoscopic display creation system will be described. Discussion will proceed to a description of an example autostereoscopically displayed image and selective diffusing thereof. Operation of the autostereoscopic display creation system and its components will then be described in more detail in conjunction with a description of an example method of method for creating an autostereoscopically displayed image and calibrating an autostereoscopically displayed image. Discussion will conclude with a description of an example computer system environment with which, or upon which, some portions or procedures of various embodiments described herein may operate.

### Example Autostereoscopic Display Creation System

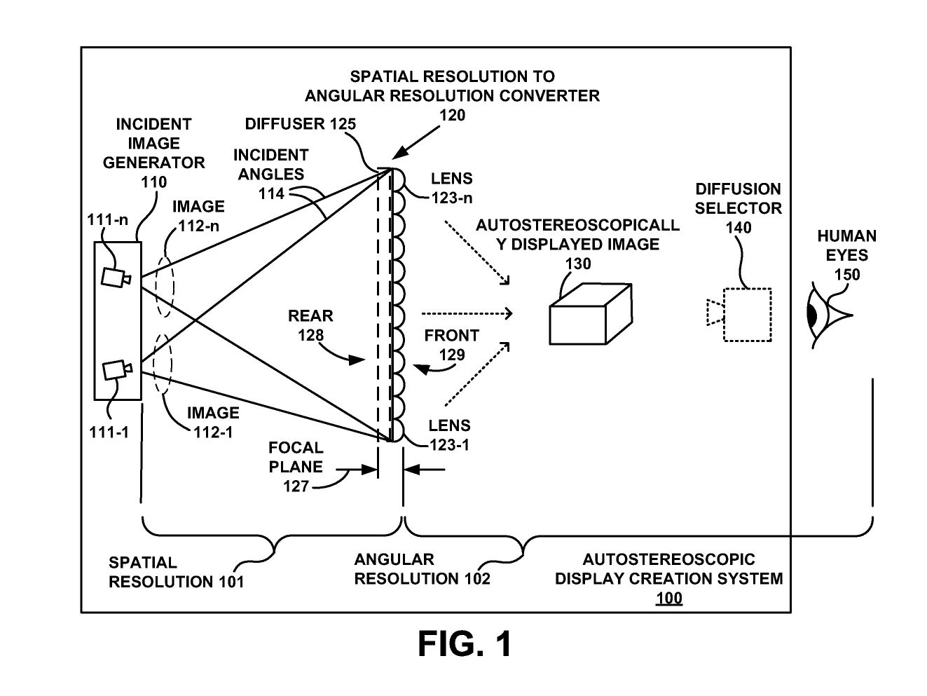

Referring now to FIG. 1, an autostereoscopic display creation system 100 is shown. System 100 utilizes a plurality of projected images and a tailored amount of diffusion to project an autostereoscopic image through an array of lenses. System 100 is a lenticular-based autostereoscopic display creation system. In the lenticular-based system, as shown in FIG. 1, an autostereoscopic image is created by projecting an image toward an array of lenses which may be located on a diffuse projection surface (e.g., a backlit screen). The projected image comprises a plurality of light rays which are received at and pass through the rear of the lenses and become light rays which are focused in a region on the front side of the lenses into what human eyes will interpret as an autostereoscopic image with 3-D properties.

As described above, some obstacles faced by conventional lenticular based autostereoscopic displays include a lack of resolution of and blurring of the autostereoscopic image. Part of the lack of resolution problem is due to low resolution of existing projectors. Part of the blurring problem can be attributed to inefficient use of the surface area of a lens and use of full diffusion screens which over diffuse projected light rays, resulting in blurring and distortion of the light rays of the projected image and consequently blurring and distortion of the resulting autostereoscopic display which is created from the light rays. These obstacles are addressed by the lenticular-based system of autostereoscopic display creation system 100. For example, as described herein, an array of projected images is used which strike a lens at different incident angles; thus concentrating greater spatial resolution on the lens surface area. Additionally, as described herein, diffusion is selectively controlled, such that a blurring of an autostereoscopically displayed image produced by the system is reduced or eliminated.

As shown in FIG. 1, system 100 comprises an incident image generator 110, a spatial-resolution-to-angular-resolution-converter (“converter”) 120, and in some embodiments, a diffusion selector 140. Together these components of system 100 are used to project autostereoscopically displayed image 130, which can be seen by a pair of human eyes 150 and can also be evaluated by diffusion selector 140 for calibrating the diffusion level used in system 100 and thus the diffusion of autostereoscopically displayed image 130. Diffusion selector 140 is shown in dotted lines as it is not used in all embodiments. Further, in some embodiments when diffusion selector 140 is used, it may be removed after use so as not to interfere with the vision field of a human (e.g. human eyes 150) when viewing the autostereoscopically displayed image 130.

Incident image generator 110 generates a plurality of images having differing incident angles with respect to converter 120. As shown in FIG. 1, incident image generator 110 generates and projects a plurality of incident images 112-1 through 112-n. In one embodiment, incident images 112 are projected at converter 120 at different angles from one another. This results in projections of light rays being received at different incident angles 114 from different image projections (112-1 to 112-n). In one embodiment, incident image generator 110 comprises a digital projector 111-1 or a plurality of digital projectors 111-1 through 111-n. In an embodiment where a single digital projector 111-1 of very high resolutions utilized, a projected image is duplicated, such as through the use of mirrors, and is projected a plurality of times from a plurality of different angles toward converter 120. It is appreciated that the resolution of the plurality of projected images is in the nature of spatial resolution in the area 101 between incident image generator 110 and a front 129 of converter 120.

Spatial-resolution-to-angular-resolution-converter 120 receives the plurality of images and creates the autostereoscopically displayed image 130 from the plurality of images. In one embodiment, converter 120 comprises a two-dimensional array of small lenses (123-1 to 123-n) which refracts and focuses light rays of incident images 112 to convert the spatial resolution to angular resolution in region 102 extending from the front 129 of converter 120. In some embodiments, converter 120 also includes a diffuser 125 which is optically coupled with lenses 123. As shown in FIG. 1, diffuser 125 is located on the rear side 128 of converter 120, within focal plane 127 of lenses 123 and converter 120, and operates to diffuse light rays of incident images 112 as they pass through converter 120. Diffuser 125 provides a selected amount of diffusion (which may be selected by diffusion selector 140) to incident images 112 before images 112 are refracted and focused by lenses 123. In this sense, diffuser 125 is behind lenses 123 (between lenses 123 and incident image generator 110) on rear side 128 of converter 120. Diffuser 125 can be comprised of any of a plurality of known diffusing materials which provide a desired and/or selected amount of image diffusion.

In one embodiment, a plurality of the projected images 112 are received at converter 120 at different incident angles from one another. This is shown in FIG. 1 by portions (e.g. light rays) of projected image 112-1 and projected image 112-n which are received converter 120 at different incident angles 114 from one another. One result of this is that light rays from each of the plurality of projected images 112 strike lenses 123 at different angles 114 and are focused and refracted through each lens 123 (e.g., lens 123-n) at different locations of the surface of each lens 123. This causes a lens surface to be used more efficiently than by one or a plurality of images or light points which strike the lens a common point in a lens (e.g., lens 123-n).

Converter 120 optically converts spatial resolution of a plurality of received incident images (e.g., images 112) to angular resolution by selectively diffusing (which can include not diffusing in some embodiments) and then refracting and focusing the received incident images 112. This conversion takes place within focal plane 127 of converter 120 as images 112 pass through converter 120, and results in the creation an autostereoscopically displayed image 130 which is viewable (on the front side 129 of lenses 123 and converter 120) by human eyes 150 and diffusion selector 140.

In one embodiment, system 100 includes diffusion selector 140 which receives and evaluates an autostereoscopically displayed image 130 created by system 100 and automatically selects a diffusion level (and appropriate diffuser 125 to provide this selected diffusion level) such that the plurality of images which pass through converter 120 are diffused just sufficiently enough to fill in voxels (volumetric pixels) of autostereoscopically displayed image 130 without overlapping the voxels with one another. In one embodiment, diffusion selector 140 comprises a digital camera which includes a processor (e.g., processor 406A of FIG. 4) or a coupling to computer system such as computer system 400 of FIG. 4.

In one embodiment, autostereoscopically displayed image 130 comprises a pre-defined test display which diffusion selector 140 receives and evaluates to determine a selected amount of diffusion to utilize with a particular configuration of converter 120 and incident image generator 110. In one embodiment, such a test display is produced without the use of a diffuser 125. The amount of light and/or light fill of voxels within the test display is evaluated by diffusion selector 140. In one embodiment, the evaluating comprises a comparison to a list of pre-defined example cases of the test image. Based on the evaluating, an amount of diffusion is then selected (such as with a look up table) which will diffuse the test image just sufficiently enough to fill in voxels of autostereoscopically displayed image 130 without overlapping the voxels with one another. Based on this diffusion selection, a diffuser 125 which provides this level of diffusion is then selected for use with or added to converter 120. In other embodiments, it is appreciated that diffusion selector 140 can evaluate a non-test image or an image which already has diffusion added to it. In such embodiments, in a similar manner as described above, diffusion selector 140 evaluates the image and selects an amount of diffusion to add or remove.

### Example Autostereoscopically Displayed Image

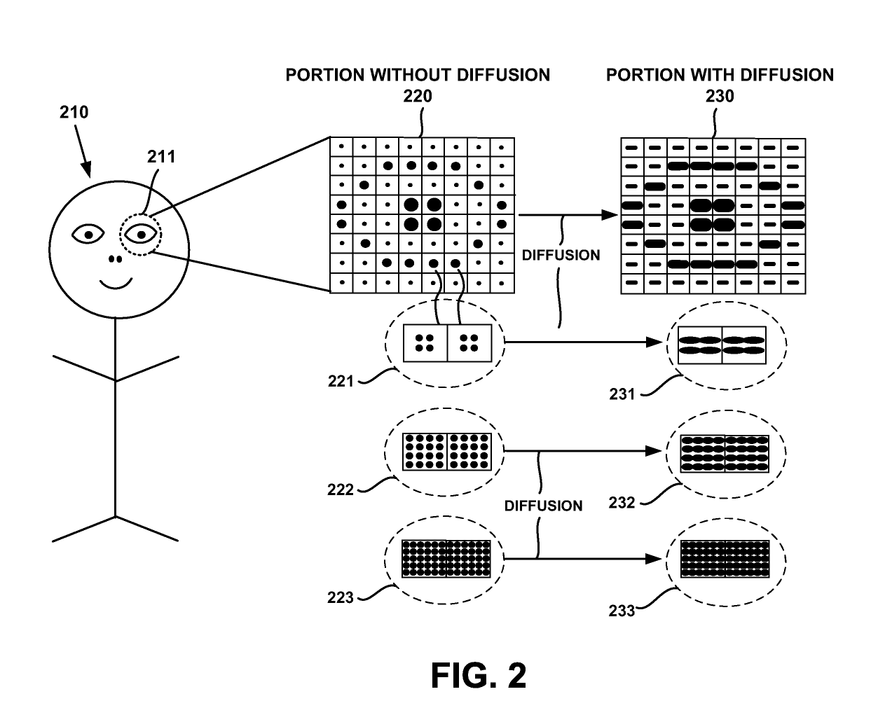

FIG. 2 shows enlarged detailed views of a portion of an example autostereoscopically displayed image 210, according to various embodiments. It is appreciated that image 210 is represented in flat two-dimensional form in FIG. 2 for ease of illustration and discussion. Enlarged details of eye 211 are shown in voxel array 220 and diffused voxel array 230. In one embodiment, each square in arrays 220 and 230 can also be thought of as representing a light ray pattern which strikes a microlens such as lens 123-n of FIG. 1, before being refracted and focused into autostereoscopically displayed image 210. These lenses/voxels are shown as square for simplicity of illustration but in other embodiments can have other shapes when viewed in a plan view, such as hexagonal.

Detail 220 shows how pointillistic that an autostereoscopically displayed image or light ray pattern can be when only a single projection source and no diffusion is utilized. By diffusing the points of detail portion 220 with a narrow angle isotropic diffuser, the points are diffused essentially into lines in detail portion 230. This stretches/distorts the points and spreads the resolution of the points until they essentially form lines across a voxel/lens without overlapping to a neighboring voxel/lens. It also preserves some amount of the resolution of the projected image by not diffusing the image to overfill the bounds of a lens/voxel and by stretching/diffusing the resolution in only one direction (in this case horizontally but not vertically).

Details 221, 222, and 223 show enlarged alternative details of two of the lenses/voxels of undiffused portion 220. In detail 221, a 2×2 array of image projections has been projected from a variety of incident angles such that four distinct and non-overlapping projected points of light now appear in each voxel/lens. In detail 222, a 4×4 array of image projections has been projected from a variety of incident angles such that sixteen distinct and non-overlapping projected points of light now appear in each voxel/lens. In detail 223, a 5×6 array of image projections has been projected from a variety of incident angles such that thirty distinct and non-overlapping projected points of light now appear in each voxel/lens. Compared to a single projection (e.g., 220), these multi-projection arrays of images received at differing incident angles more efficiently utilize the available surface area of a lens, increase the image resolution that is received by a lens, and also increase the light fill and resolution of a voxel of an autostereoscopic image. As can be seen in the diffused versions, 231, 231, and 233, as more of the projected points are received a differing incident angles, progressively less diffusion (in these cases isotropic diffusion) is needed to eventually fill a lens/voxel (without overfilling). Following this pattern, it can be seen that a large enough array of projected points of light (e.g., 100×100) striking a lens at differing incident angels would need little to no diffusion because it would substantially fill the surface area of the lens without use of any diffusion.

It is appreciated that in one embodiment, diffusion selector 140 analyzes a pattern of projected points of light such as detail 222 to determine the amount of diffusion, if any, which needs to be added to achieve a light pattern which is diffused to a particular pre-selected level of diffusion (e.g., the level of diffusion shown in detail 232) which fills but not overfills a lens/voxel. With such selectively controlled diffusion, each projection of an image defines a smaller area of each lens than in conventional techniques, greatly facilitating the reduction of optical distortions. Such a plurality of projections can also be mapped as points of light in autostereoscopically displayed image 210 (such as in voxels 221, 222, and 223) and then evaluated or compared, using diffusion selector 140 (such as to stored patterns) to determine a level of diffusion to apply.

### Example Methods of Operation

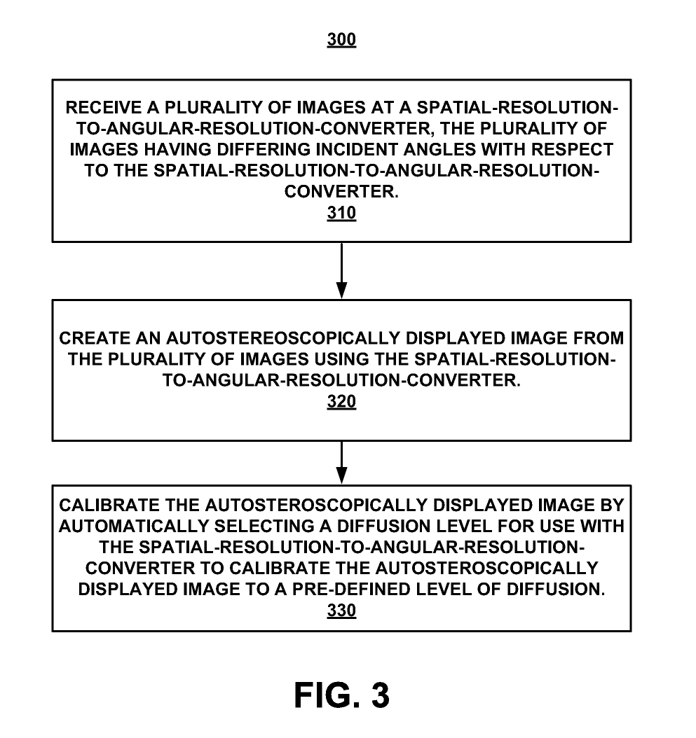

The following discussion sets forth in detail the operation of some example methods of operation of embodiments. With reference to FIG. 3, flow diagram 300 illustrates example procedures used by various embodiments. Flow diagram 300 includes some procedures that, in various embodiments, are carried out by a processor under the control of computer-readable and computer-executable instructions. The computer-readable and computer-executable instructions can reside in any tangible computer readable media, such as, for example, in data storage features such as computer usable volatile memory 408, computer usable non-volatile memory 410, peripheral computer-readable media 402, and/or data storage unit 412 (all of FIG. 4). The computer-readable and computer-executable instructions, which reside on tangible computer useable media, are used to control or operate in conjunction with, for example, processor 406A and/or processors 406A, 406B, and 406C of FIG. 4. Although specific procedures are disclosed in flow diagram 300, such procedures are examples. That is, embodiments are well suited to performing various other procedures or variations of the procedures recited in flow diagram 300. It is appreciated that the procedures in flow diagram 300 may be performed in an order different than presented, and that not all of the procedures in flow diagram 300 may be performed.

### Example Method of Creating and Calibrating an Autostereoscopically Displayed Image

FIG. 3 illustrates a flow diagram 300 of an example embodiment of a method of creating an autostereoscopically displayed image and calibrating the autostereoscopically displayed image. Elements and procedures of flow diagram 300 are described below, with reference to elements of FIG. 1 and FIG. 2.

At 310 of flow diagram 300, in one embodiment, the method receives a plurality of images 112-1 to 112-nat spatial-resolution-to-angular-resolution-converter 120. In one embodiment, each of the received plurality of images has a different incident angles with respect to converter 120. In one embodiment the plurality of images 112-1 to 112-nis projected by and received from incident image generator 110. In one embodiment, the received images 112-1 to 112-n are generated (and duplicated such as with mirrors) from a projection of a single projector 111-1 of incident image generator 110. In one embodiment, the received images 112-1 to 112-n are generated as projections of a plurality of projectors 111-1 to 111-n of incident image generator 110.

At 320 of flow diagram 300, in one embodiment, the method creates an autostereoscopically displayed image 130 from the plurality of images 112-1 to 112-n using converter 120. In one embodiment, this comprises diffusing the plurality of images 112-1 to 112-n which pass through converter 120. Diffuser 125, which can be included in converter 120, is used to perform this diffusing. This can comprise, in one embodiment, isotropically diffusing the plurality of images 112-1 to 112-n which pass through converter 120. This can comprise, in another embodiment, anisotropically diffusing the plurality of images 112-1 to 112-n which pass through converter 120. For example, as shown in FIG. 2, this can comprise diffusing a plurality of pointillistic images (or rays of light from images). FIG. 2 shows a plurality of images diffused to create what is substantially a line which is diffused on one of a horizontal and vertical axis, but not the other. This is shown in details 230, 231, 232, and 233 of FIG. 2 where the arrays of points are substantially diffused into arrays of lines.

In one embodiment, creating an autostereoscopically displayed image 130 from the plurality of images 112-1 to 112-n using converter 120 comprises diffusing the plurality of images 112-1 to 112-n which pass through the converter 120 such that lens space in a lens of converter 120 is just filled by images of the plurality of images which are received by the lens. As shown in, for example, detail 231, 232, and 233, this can comprise diffusing the light rays of the received image in one of a horizontal or vertical direction until the diffused images just fill to the edges of a lens (e.g., lens 123-1) without spilling out of the edges of the lens. Likewise (though not illustrated), the same type of controlled diffusion can be accomplished on both horizontal and vertical axis in one embodiment. In a similar manner, this can comprise diffusing the plurality of images 112-1 to 112-n which passes through the converter 120 until the images are diffused sufficiently to fill the voxels of autostereoscopically displayed image 130 without overlapping diffused light into adjacent voxels of autostereoscopically displayed image 130. This is illustrated in FIG. 2 by diffused details 231, 232, and 233 which are represent voxels with light diffused to a point of filling the voxels but not spilling over out of the voxel or into an adjacent voxel.

At 330 of flow diagram 300, in one embodiment, the method calibrates the autostereoscopically displayed image 130 (and thereby also calibrates autostereoscopic display creation system 100) by automatically selecting a diffusion level for use with converter 120 to calibrate autostereoscopically displayed image 130 to a pre-defined level of diffusion. In one embodiment, diffusion selector 140 evaluates autostereoscopically displayed image 130, which may comprise a test display used specifically for calibration purposes, and selects the level of diffusion to apply. In one embodiment, this comprises, automatically evaluating autostereoscopically displayed image 130 with diffusion selector 140 to select a diffusion level and associated diffuser 125 such that the plurality of images 112-1 to 112-n which pass through the converter 120 are diffused sufficiently to just fill voxels of autostereoscopically displayed image 130 without overlapping the voxels with one another. This can be done in the manner described above, to provide diffusion as illustrated by example in FIG. 2 with details 231, 232, and 233. It is appreciated that in some embodiments where sufficiently large arrays of projected images (e.g., 50×50, 100×100, 1000×1000) are received at converter 120, diffusion selector 140 may determine that the proper level of diffusion is no diffusion. In such a case diffuser 125 would not be included in converter 120 or if included would provide no diffusion.

### Example Computer System Environment

With reference now to FIG. 4, portions of some embodiments described herein are composed of computer-readable and computer-executable instructions that reside, for example, in computer-usable/computer-readable media of a computer system. FIG. 4 illustrates one example of a type of computer (computer system 400) that can be used in accordance with or to implement various embodiments which are discussed herein. It is appreciated that computer system 400 of FIG. 4 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. As shown in FIG. 4, computer system 400 of FIG. 4 is well adapted to having peripheral computer-readable media 402 such as, for example, a floppy disk, a compact disc, and the like coupled thereto.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C. System 400 also includes computer usable non-volatile memory 410, e.g. read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alphanumeric input device 414 including alphanumeric and function keys coupled to bus 404 for communicating information and command selections to processor 406A or processors 406A, 4068, and 406C. System 400 also includes an optional cursor control device 416 coupled to bus 404 for communicating user input information and command selections to processor 406A or processors 406A, 406B, and 406C. In one embodiment, system 400 also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alphanumeric characters recognizable to a user. Optional cursor control device 416 allows the computer user to dynamically signal the movement of a visible symbol (cursor) on a display screen of display device 418 and indicate user selections of selectable items displayed on display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands. System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet.

Referring still to FIG. 4, various other components are depicted for system 400. Specifically, when present, an operating system 422, applications 424, modules 426, and data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, computer-readable media within data storage unit 412, peripheral computer-readable media 402, and/or other tangible computer readable media.

Example embodiments of the subject matter are thus described. Although various embodiments of the subject matter have been described in a language specific to structural features and/or methodological acts, it is to be understood that the appended claims are not necessarily limited to the specific features or acts described above. Rather, the specific features and acts described above are disclosed as example forms of implementing the claims.

What is claimed is:

1. A method 300 of creating an autostereoscopically displayed image, the method comprising:
receiving 310 a plurality of images at a spatial-resolution-to-angular-resolution-converter 120, the plurality of images having differing incident angles with respect to the spatial-resolution-to-angular-resolution-converter 120; and
creating 320 an autostereoscopically displayed image from the plurality of images using the spatial-resolution-to-angular-resolution-converter 120.

2. The method 300 as recited in claim 1, wherein said receiving 310 a plurality of images at a spatial-resolution-to-angular-resolution-converter 120 comprises:
receiving 310 the plurality of images from an incident image generator 110.

3. The method 300 as recited in claim 2, wherein said receiving the plurality of images from an incident image generator 120 comprises:
receiving the plurality of images generated from a projection of a single projector 112-1.

4. The method 300 as recited in claim 2, wherein said receiving the plurality of images from an incident image generator 110 comprises:
receiving the plurality of images generated from projections of a plurality of projectors 112.

5. The method 300 as recited in claim 1, wherein said creating 320 of an autostereoscopically displayed image from the plurality if images using the spatial-resolution-to-angular-resolution-converter 120 further comprises:
diffusing the plurality of images which pass through the spatial-resolution-to-angular-resolution-converter 120.

6. The method 300 as recited in claim 5, wherein said diffusing the plurality of images which pass through the spatial-resolution-to-angular-resolution-converter 120 comprises:
isotropically diffusing the plurality of images which pass through the spatial-resolution-to-angular-resolution-converter 120.

7. The method 300 as recited in claim 5, wherein said diffusing the plurality of images which pass through the spatial-resolution-to-angular-resolution-converter 120 comprises:
anisotropically diffusing the plurality of images which pass through the spatial-resolution-to-angular-resolution-converter 120.

8. The method 300 as recited in claim 5, wherein said diffusing the plurality of images which pass through the spatial-resolution-to-angular-resolution-converter 120 comprises:
diffusing the plurality of images which pass through the spatial-resolution-to-angular-resolution-converter 120 such that lens space in a lens of the spatial-resolution-to-angular-resolution converter 120 is just filled by images of the plurality of images which are received by the lens.

9. The method 300 as recited in claim 5, wherein said diffusing the plurality of images which pass through the spatial-resolution-to-angular-resolution-converter comprises:
diffusing the plurality of images which pass through the spatial-resolution-to-angular-resolution-converter 120 the images are diffused sufficiently to fill voxels of the autostereoscopically displayed image without overlapping diffused light into adjacent voxels.

10. A method 300 of calibrating an autostereoscopically displayed image, the method comprising:
receiving 310 a plurality of images at a spatial-resolution-to-angular-resolution-converter 120, the plurality of images having differing incident angles with respect to the spatial-resolution-to-angular-resolution-converter 120;
creating 320 an autostereoscopically displayed image from the plurality of images using the spatial-resolution-to-angular-resolution-converter 120; and
calibrating 330 the autostereoscopically displayed image by automatically selecting a diffusion level for use with the spatial-resolution-to-angular-resolution-converter 120 to calibrate the autostereoscopically displayed image to a pre-defined level of diffusion.

11. The method 300 as recited in claim 10, wherein said receiving 310 a plurality of images at a spatial-resolution-to-angular-resolution-converter comprises:
receiving the plurality of images from an incident image generator 110.

12. The method 300 as recited in claim 10, wherein said calibrating 330 the autostereoscopically displayed by automatically selecting a diffusion level for use with the spatial-resolution-to-angular-resolution-converter to calibrate the autostereoscopically displayed image to a pre-defined level of diffusion comprises:
automatically evaluating the autostereoscopically displayed image with a diffusion selector 140 to select a diffuser 125 such that the plurality of images which pass through the spatial-resolution-to-angular-resolution-converter 120 are diffused sufficiently to just fill voxels of the autostereoscopically displayed image 130 without overlapping the voxels with one another.

13. A system 100 for creating an autostereoscopically displayed image 130, 210, the system comprising:
an incident image generator 110 configured for generating a plurality of images 112 having differing incident angles 114 with respect to a spatial-resolution-to-angular-resolution-converter 120; and
the spatial-resolution-to-angular-resolution-converter 120 configured for receiving the plurality of images 112 and for creating the autostereoscopically displayed image 130, 210 of the plurality of images 112.

14. The system 100 of claim 13, further comprising:
a diffuser 125 optically coupled with the spatial-resolution-to-angular-resolution-converter 120, the diffuser 125 configured to diffuse the plurality of images 112 which pass through the spatial-resolution-to-angular-resolution-converter 120.

15. The system 100 of claim 13, further comprising:
a diffusion selector 140 configured to evaluate the autostereoscopically displayed image 130, 210 and select a diffuser 125 such that the plurality of images 112 which pass through the spatial-resolution-to-angular-resolution-converter 120 are diffused just sufficiently to fill voxels 231, 232, 233 of the autostereoscopically displayed image 130 without overlapping the voxels 231, 231, 233 with one another 231, 232, 233.
